(19) United States
(12) Patent Application Publication
(10) Pub. No.: US 2019/0174688 A1
(43) Pub. Date: Jun. 13, 2019

(54) WATERING DEVICE

(71) Applicant: Rami Elkhatib, Lilburn, GA (US)

(72) Inventor: Rami Elkhatib, Lilburn, GA (US)

(21) Appl. No.: 15/835,825

(22) Filed: Dec. 8, 2017

(51) Int. Cl. A01G 27/00

(52) U.S. Cl. CPC A01G 27/006

(57) ABSTRACT

Watering devices are disclosed. In one embodiment, a watering device may include a fitting for a vessel comprising a channel and a filament configured to be received in the channel. The fitting may be received in the vessel comprising a fluid. The fluid may flow from an interior of the vessel to an exterior of the vessel through the channel. The filament may be sized to regulate the flow of the fluid through the channel.

### BACKGROUND OF THE INVENTION

### 1. Field of the Invention

The present disclosure generally relates to a watering device.

### 2. Description of the Related Art

It is common to see above-ground watering devices, such as watering globes, in gardens and in household potted plants. These devices are typically filled with water, and then turned over so that water can flow into the soil.

### SUMMARY OF THE INVENTION

Watering devices are disclosed. In one embodiment, a watering device may include a fitting for a vessel comprising a channel and a filament configured to be received in the channel. The fitting may be received in the vessel comprising a fluid. The fluid may flow from an interior of the vessel to an exterior of the vessel through the channel. The filament may be sized to regulate the flow of the fluid through the channel.

In one embodiment, the fitting may comprise cork, plastic, bamboo, fiberglass, etc. In one embodiment, the vessel may comprise an opening, and the fitting may be received in the opening.

In one embodiment, the vessel may be in communication with a water source.

In one embodiment, the vessel may be received by a dock.

According to another embodiment, a method of providing a fluid to an area may include (1) providing a vessel comprising an opening with a fluid; (2) inserting a fitting into the opening, the fitting comprising a channel having a filament inserted therein; and (3) orienting the vessel such that the fluid flows through the channel to an area. The filament may be configured to regulate the flow of the fluid through the channel.

In one embodiment, the fitting may comprise cork, plastic, bamboo, fiberglass, etc. In one embodiment, the vessel may comprise an opening, and the fitting may be received in the opening.

In one embodiment, the vessel may be in communication with a water source.

In one embodiment, the vessel may be received by a dock.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a watering device according to one embodiment;

FIG. 2 depicts a watering device according to another embodiment;

FIG. 3 depicts a watering system according to another embodiment; and

FIG. 4 depicts a watering system according to another embodiment.

### DETAILED DESCRIPTION OF PREFERRED EMBODIMENTS

Embodiments disclosed herein relate to watering devices. Embodiments may assist with the watering or irrigation of plants, or to deliver a liquid from a vessel, or container, to a desired place or area.

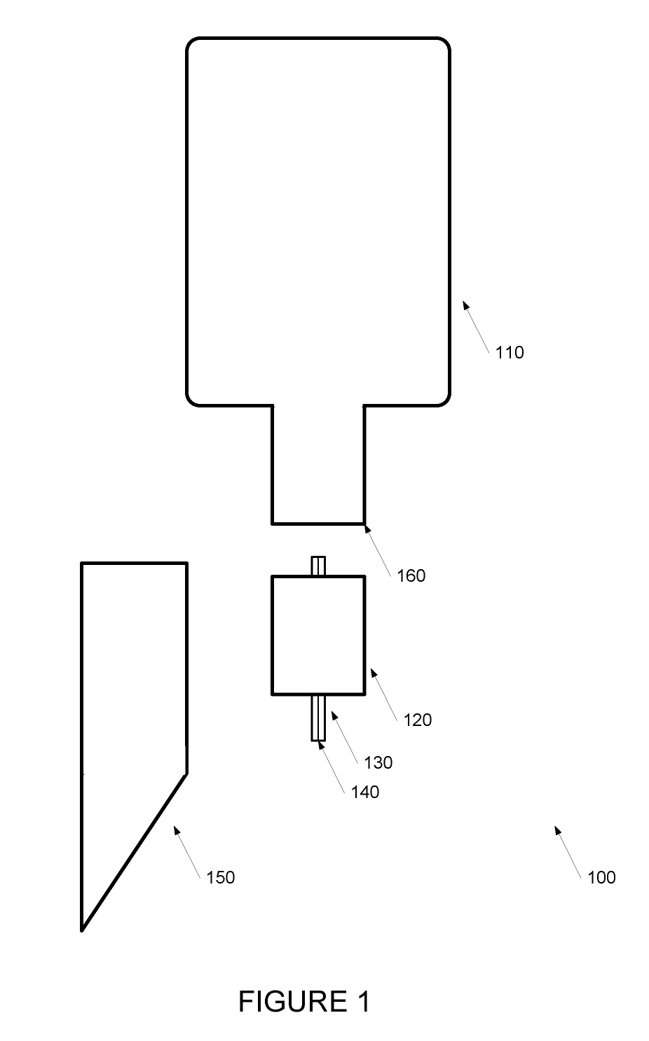

Referring to FIG. 1, a watering system is disclosed according to one embodiment. System 100 may include, for example, vessel 110, fitting 120, channel 130, filament 140, and dock 150. Vessel 110 may be any suitable vessel for holding or providing a liquid, such as water, and may be made of any suitable material. For example, vessel 110 may be made of glass, water, metal, cardboard, wood, etc.

Although a bottle-type vessel 110 is depicted in FIG. 1, it should be recognized that vessel 110 may include buckets, hoses, tubes, irrigation systems, bowls, funnels, cisterns, boxes, vases, or any other suitable containment device.

Fitting 120 may be inserted into opening 160 of vessel 110. In one embodiment, fitting 120 may be made of any suitable material such as rubber, cork, plastic, etc.

Fitting 120 may be provided with channel 130 that may permit fluid and gas communication. In one embodiment, channel 130 may be an opening formed in fitting 120; in another embodiment, channel 130 may be provided as a tube, straw, etc. in fitting 120. Other arrangements may be provided as is necessary and/or desired. Channel 130 may exist entirely within fitting 120, or may extend outside of both ends of fitting 120.

Although one channel 130 is depicted in FIG. 1, it should be noted that a greater number of channels 130 may be provided as is necessary and/or desired.

In one embodiment, fitting 120 may be configured to attach to two vessels 110. For example, one end of fitting 120 may be inserted into a first vessel 110, and a second end may be inserted into a second vessel 110. Channel 120 may connect both vessels 110 and may include an output along the fitting.

In one embodiment, fitting 120 may connect two vessels 110 such that fluid from one vessel 110 may be transferred to the other vessel 110 due to gravity. The size of channel 130 and/or filament 130, or the amount of a liquid, may be selected to indicate the passage of a predetermined amount of time. This may be used, for example, for a water-based hourglass.

Filament 140 may be provided within channel 130. Filament 140 in conjunction with channel 130 may regulate a flow of liquid from the interior of vessel 110 through fitting 120.

Filament 140 may be made of any suitable material, including for example bamboo, paper, plastic, metal, fiberglass, etc. In one embodiment, a length of filament 140 may be matched to the length of channel 130.

In one embodiment, fitting 120 may be inserted into an end of vessel 110 that may be filled with a liquid (not shown) such as water.

In one embodiment, vessel 110 may include linear or nonlinear incisions or grooves (not shown) in the surface that contacts fitting 120 to permit liquid to flow between vessel 110 and fitting 120. The incisions may be provided at various intervals along the interior of cylinder 110. Alternatively, fitting 120 may include incisions or grooves (not shown) on its exterior surface to provide similar functionality.

Dock 150 may be provided and may be inserted into soil to be watered. Dock 150 may be hollow and may be sized to receive the end of vessel 110 that includes fitting 120 and may be sized so that vessel 110 is oriented to release water through channel 130. Dock 150 may be made of any suitable material, including plastic, PVC, wood, glass, metal, etc.

In one embodiment, dock 150 may keep vessel 110 from contacting the soil.

In one embodiment, the use of dock 150 may be optional; vessel 110 may be directly inserted into soil without using dock 150.

In one embodiment, vessel 110 may have an end that is cut at an angle (not shown) for easy insertion into the soil. Dock 150 may be similarly angled at one end. Fitting 120 may be similarly angled, tapered, etc., as is necessary and/or desired.

Embodiments disclosed herein may be used indoors, outdoors, in gardens, in greenhouses, in potted plants, for hydroponic growing systems, or for any substrate. Further, device 100 may be used with additional items or materials, such as compression rings or sealants, as is necessary and/or desired.

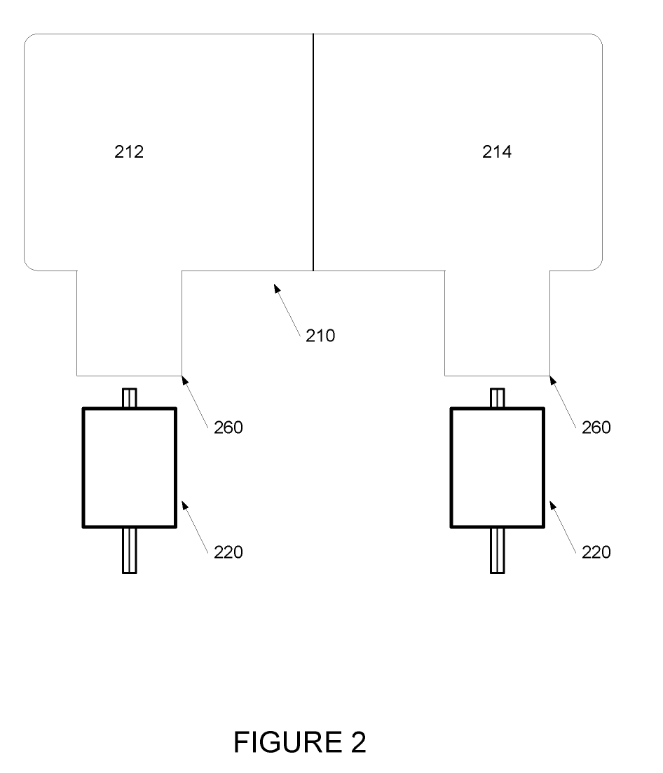

Referring to FIG. 2, in one embodiment, vessel 210 may be provided with a plurality of openings 260, and each opening 260 may be provided with fitting 210. In one embodiment, vessel 210 may be provided with a plurality of chambers 212, 214 that may store different fluids for delivery.

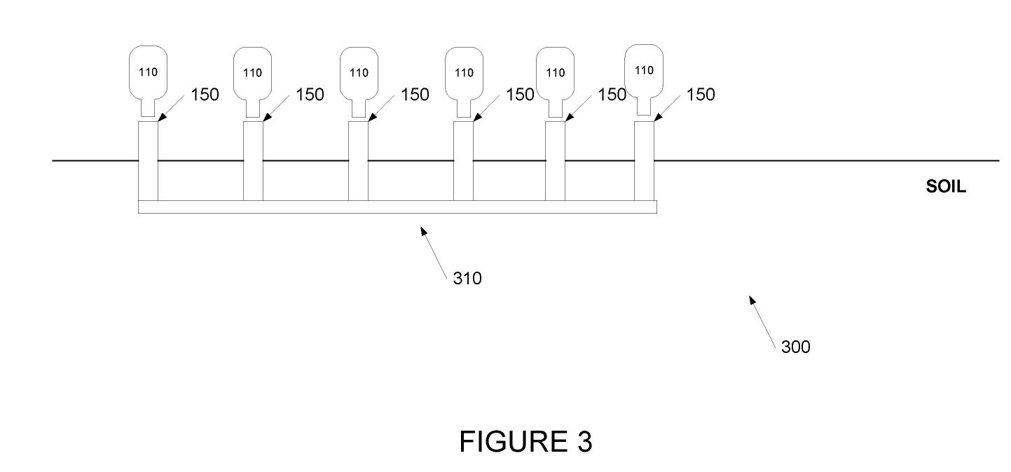

Referring to FIG. 3, a system for watering is depicted according to another embodiment. System 300 may include a plurality of docks 150 that may be in communication with irrigation channel 310, which may be made of any suitable material. In one embodiment, irrigation channel 310 may have hole or openings (not shown) to allow liquid to pass through irrigation channel 310 and flow into the soil. Irrigation channel may be made of any suitable material, including plastic, PVC, metal, etc.

Each dock 150 may receive a vessel 110 with fitting 120, channel 130, and filament 140.

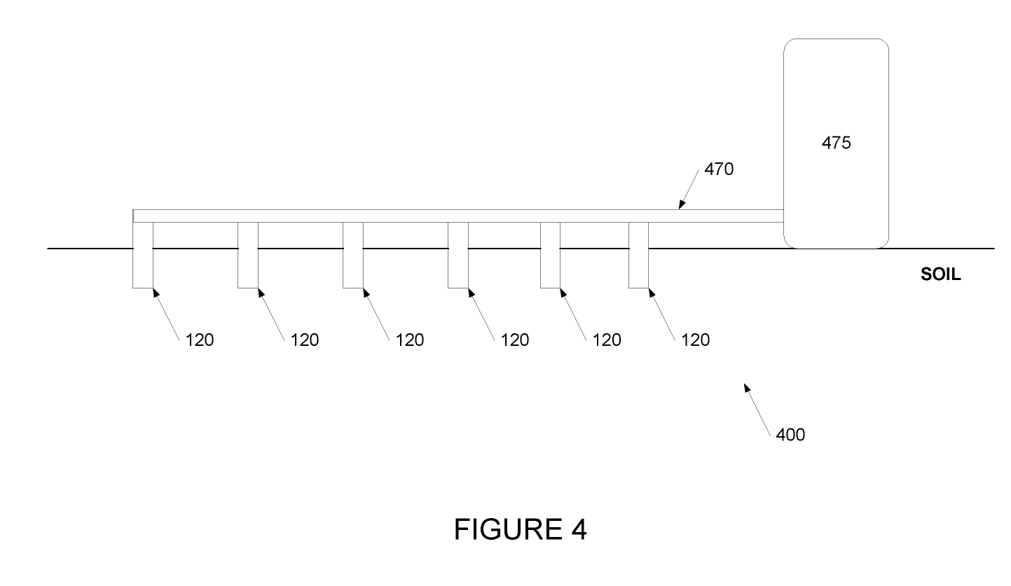

Referring to FIG. 4, in one embodiment, system 400 may be provided with conduit 470 that may deliver a fluid from water source 475 (e.g., a rain barrel, irrigation system, lake, stream, pond, etc.) and may deliver the liquid to the soil. Conduit 470 may be placed above soil, or buried in soil. Conduit 470 may have a plurality of openings, each of which may receive fitting 120 as describe above.

It should be noted that any of the elements described above may have any suitable size, shape, or dimension that is necessary and/or desired.

It should be recognized that although several embodiments have been disclosed, these embodiments are not exclusive and aspects of one embodiment may be applicable to other embodiments.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A watering device comprising:
a fitting for a vessel comprising a channel;
a filament configured to be slideably received in the channel;
wherein:
the fitting is received in the vessel comprising a fluid;
the fluid flows from an interior of the vessel to an exterior of the vessel through the channel; and
the filament is sized to regulate the flow of the fluid through the channel.

2. The watering device of claim 1, wherein the fitting comprises cork.

3. The watering device of claim 1, wherein the fitting comprises plastic.

4. The watering device of claim 1, wherein the filament comprises bamboo.

5. The watering device of claim 1, wherein the filament comprises fiberglass.

6. The watering device of claim 1, wherein the vessel comprises an opening, and the fitting is received in the opening.

7. The watering device of claim 1, wherein the vessel is in communication with a water source.

8. The watering device of claim 1, wherein the vessel is received by a dock.

9. A method of providing a fluid to an area, comprising:
providing a vessel comprising an opening with a fluid;
inserting a fitting into the opening, the fitting comprising a channel having a filament inserted therein; and
orienting the vessel such that the fluid flows through the channel to an area;
wherein the filament is configured to regulate the flow of the fluid through the channel.

10. The method of claim 9, wherein the fitting comprises cork.

11. The method of claim 9, wherein the fitting comprises plastic.

12. The method of claim 9, wherein the filament comprises bamboo.

13. The method of claim 9, wherein the filament comprises fiberglass.

14. The method of claim 9, wherein the vessel comprises an opening, and the fitting is received in the opening.

15. The method of claim 9, wherein the vessel is in communication with a water source.

16. The method of claim 9, wherein the vessel is received by a dock.
